(19) United States
(12) Patent Application Publication
(10) Pub. No.: US 2005/0010532 A1
(43) Pub. Date: Jan. 13, 2005

(54) Self-service customer license management application using software license bank

(75) Inventors: Carey E. Garibay, Campbell, CA (US); Quoc Le, Burlingame, CA (US); Eva Tsai, Cupertino, CA (US)

Correspondence Address: FLIESLER MEYER, LLP, FOUR EMBARCADERO CENTER, SUITE 400, SAN FRANCISCO, CA, 94111, US

(73) Assignee: Bea Systems, Inc., San Jose, CA (US)

(21) Appl. No.: 10/656,476

(22) Filed: Sep. 5, 2003

Related U.S. Application Data
(60) Provisional application No. 60/485,867, filed on Jul. 9, 2003.

(51) Int. Cl. G06F 17/60

(52) U.S. Cl. 705/59

(57) ABSTRACT

A license management unit is described which provides for a web based access to digital records for software licenses. The digital records can indicate rights associated with the software license. A transaction history can be maintained including adjustments of the rights associated with the software license.

### BACKGROUND

The present invention relates to methods and systems for managing software licenses. Software is typically licensed to customers rather than being sold outright. In some cases, the software is licensed for use by a single user or on a single computer. The software can be “IP locked” meaning that the software can be used at a single Internet Protocol (IP) address. In “IP locked” systems, a license key defines the environment that the software can be used.

License management systems have been devised in order to maintain licenses for companies. This is especially a concern when a company has a large number of licenses for a variety of different computers, across multiple sites and geographies, and distributed to many developers or technical personnel across the customer's enterprise.

### BRIEF DESCRIPTION OF THE DRAWINGS

FIG. 1 is a diagram that illustrates a system of one embodiment of the present invention.

FIG. 2 is a diagram of a license management unit used in one embodiment of the present invention.

FIG. 3 is an exemplary web page flow diagram (site map) for a web application of one embodiment of the present invention.

FIG. 4 is a diagram of a software architecture for one embodiment of a license management unit of the present invention.

### DETAILED DESCRIPTION

Embodiments of the present invention concern methods and systems for customers to self-manage their software license environment dynamically, while maintaining compliance with the terms of their license purchases. The web application provides customers with the control, while reducing administrative burden to the licensee and/or licensor.

Four important process components are use in different embodiments of the present system:
1. User Access Administration—This process can include the ability to grant access to the web application, to both customers and internal users of the licensor or licensee. In one embodiment, a customer administration application allows customers to manage access of their internal users. The customer administration application can allow a customer administrator to set license information access and license modification rights for internal users. The customer administration application can prompt internal users to supply additional environment and license information that can be used in controlling the access and modification rights.
2. Self-Service License Management—There are several unique processes supported through the web application enabling customers to manage their license environment; including, but not limited to initial and on-going license retrieval, license tracking, license transfer, version upgrades and downgrades, update machine configuration, license reconfiguration, prepaid license “burndown” retrieval, database update requests and entitlement tracking.
3. Historical License Life Cycle Reporting—In one embodiment, transaction histories for the license can be provided to users. The transaction histories can use a unique license ID, which is constant throughout the life of the license entitlement.
4. Asset Management—in one embodiment, the stored license information can be the focus of Search and Reporting for operational reports, customer specific reporting and cross-customer reporting and analysis.

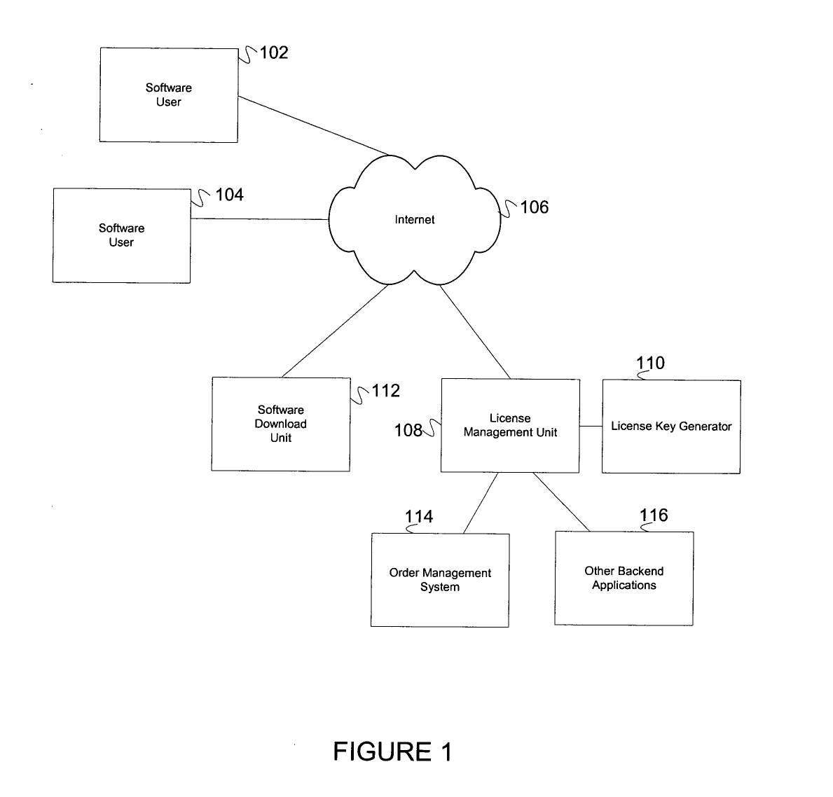

FIG. 1 is a diagram that illustrates one embodiment of the present invention. The software users 102 and 104 can connect across the internet 106 to the license management unit 108. In one embodiment, the license management unit 108 is software loaded onto one or more servers. The license management unit 108 can be associated with a license key generator 110, which produces the license keys for the operation of the software. Also, shown is a software download unit 112. In one example, the software user 102 or 104 downloads the software from unit 112. The license management unit 108 can cause the license key generator to produce the license key for the software. In one embodiment, the key is associated with the software version and/or is locked for an “IP address”. In one embodiment, software users 102 and 104 interact with the license management unit 108 using a web application.

The license management unit 108 can include an order agent, which periodically checks the database to see what notifications need to be made to the users. For example, the database can be shared with an order management system 114, such as those available from Enterprise Resource Planning (ERP) vendors, such as PeopleSoft, which adds new orders to the database. The information in the database can be checked by order agent periodically and determined whether a license key needs to be generated to be provided to the software user. The license management unit 108 can also interact with other backend applications 116. In one embodiment, the interaction between the license management unit 108 and the license key generator 110 can use the Java Messaging Services (JMS).

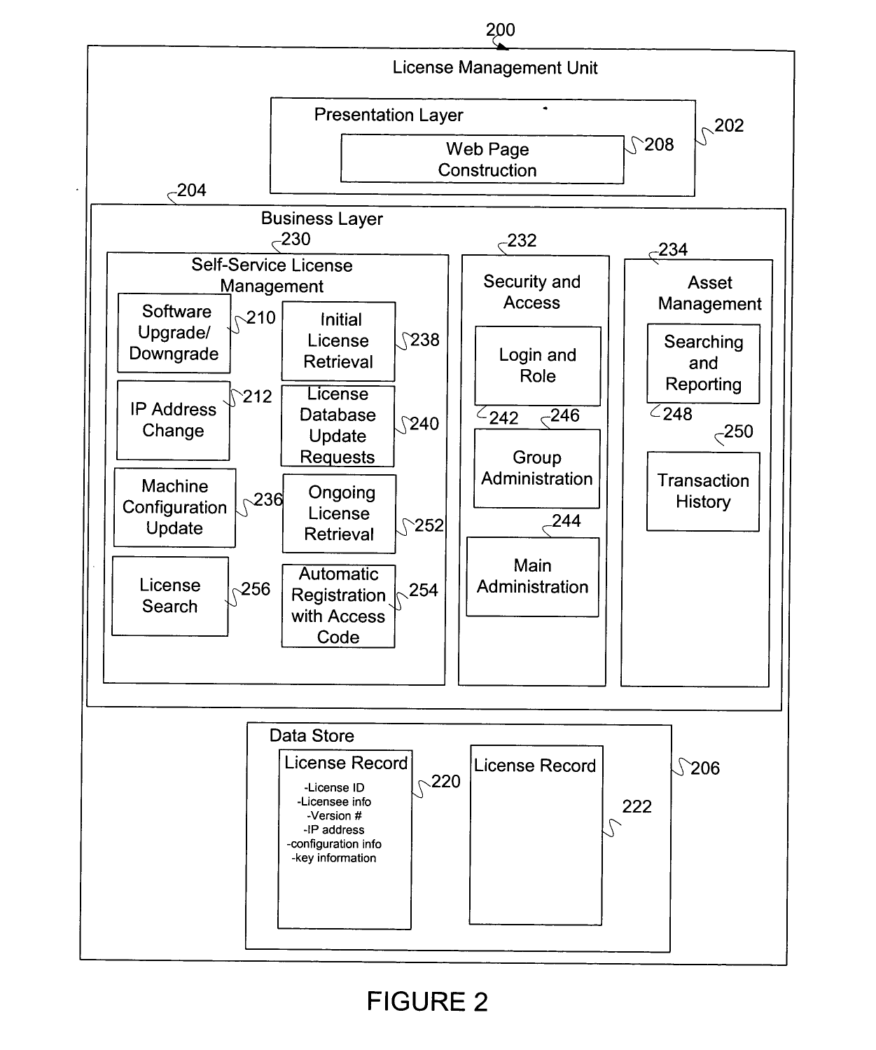

FIG. 2 illustrates an example of a license management unit 200. In this example, the license management unit includes multiple software layers. The software includes a presentation layer 202, business layer 204 and data store 206. In this example, the presentation layer 204 includes web page construction unit 208. The web page construction unit 208 is used to produce the web pages.

Business layer 204 contains business logic for the license management unit. In this example, the business layer 204 includes business logic for self-service license management. In one embodiment, this logic allows users to update and modify the software license information without requiring intervention by administrators.

In one embodiment, software upgrade/downgrade logic 210 contains logic that allows for the upgrade/downgrade of the software version for the license. In one embodiment, the upgrade/downgrade can cause the construction of a new license key. The new license key can be provided by the user across the web page or using e-mail for security.

IP address change logic 212 can allow the user to input a new IP address for the software license, which is important for “IP locked” software. The IP address change can also be associated with the construction of a new license key that will work for the new IP address. In one embodiment, the old license for the old IP address is automatically invalidated.

Machine configuration update logic 236 allows a user to update configuration information to be associated with a license. The configuration information can include platform, database, machine name, domain name, environment, operating system as well as data defined by individual customers, based on their unique license tracking requirements. This information may be useful to help the user keep track of the software licenses.

In one embodiment, the initial license retrieval logic 238 is used to provide license keys to the users. Once a software order is made, an email with an encrypted Universal Resource Locator (URL) can be sent to the user. The user can use the encrypted URL to go to a web page that allows a software license key to be downloaded. The encrypted URL is encrypted in the sense that it would be difficult for someone to guess the URL. The use of an encrypted URL address for the web page means that a login is not required to access the license key. The encrypted URL can be sufficiently long and sufficiently unrelated to other encrypted URLs that the encrypted URL is unlikely to be guessed. In one embodiment, each license key can only be downloaded once from the web page and once all license keys are downloaded from the web page, the web page is deleted.

An authorization code for use with the license management system can also be provided with the email. The authorization code allows access to the software license information through an automated pre-approval of the registrant, based on use of the authorization code. The automatic update with authorization code unit 254 can be used to update the license information into a database when the authorization code is provided.

In one embodiment, another copy of the license key can be obtained after login using the ongoing license retrieval unit 252. The license search unit 256 can be used to search the database for a software license. The license database update request logic 240 allows for the creation of requests to update the database with a license that is missing from the database. If an authorized software license is missing from the database, the license database update request logic 240 allows for inputting information related to the license so that a licensor administrator can update the database with the license information. A web application can prompt the user to provide information useful for determining the license is valid. This information can include company name, license ID, serial numbers and the like.

The business layer 204 can also include security and access logic 232. In one embodiment, login and role logic 242 allows a user to login. In one embodiment, the login process assigns each user a role. The roles can include main administrator, group administrator, as well as other user roles. The role can affect the web pages presented, as well as access and modification rights to the software license data. For example, users may only be able to view and modify licenses of the group that they are members. The login can be a single sign-on associated with a number of applications.

The main administration logic 244 allows administrators to access and modify licenses as required. In one embodiment, the administrators receive requests from users including requests to add missing licenses. The main administration logic 244 allows for actions such as changing email addresses that could be a security problem if allowed to be done by users.

The group administration logic 246 allows group administrators to control the access and modification rights of the software license data for members of a group. The group can be a company. In one embodiment, the group administration logic 246 allows for the customization of functions represented by the web pages that are accessed by group members. In one embodiment, inputted field information is a customer defined field and the access rules are such that some group members can only access software license information associated with the customer definition. For example, the group administrator can require group members to input data such as department, location etc. The group administrator can restrict access to software license information based on these fields. In one embodiment, customizable fields can be used to request information from group members. This additional information helps the group administrator control and keeps track of the software licenses.

Asset management logic 234 can be used for keeping track of the software licenses. In one embodiment, the asset management logic 234 includes searching and reporting logic 248 that so that a user can search for software license data as well as to produce reports based on searches. For example, spreadsheet, text or other reports can be produced that allow software license data to be easily viewed by users offline. The search logic allows users to find licenses and transactions as well as to view license and transaction information.

In one embodiment, transaction history logic 250 is used so that users can see a transaction history associated with a license. A license ID can be used associated with each software license. The license ID can be used to keep track of the software license even after the configuration information, IP address, and software version has changed. The transaction history can indicate information related to each relevant transaction including date, user making the change, status and old version, configuration, and IP address information.

In this example, the data store 206 includes license records 220 and 222. The license records can include: license ID; licensee information such as the licensee name, company name, location; software version number information which indicates the software version; IP address which is important for the IP locked software; and configuration information, which can include the information useful to the software user in searching for specific licenses. Additionally, the license key may also be a part of the digital record. In one embodiment, a single license ID is used for a license throughout all of the transactions. The transactions can include changing the IP address, changing the license version, etc.

The license management unit can be used for one or more software vendors' licenses. The license management software can include a customization module (not shown) that allows for the adjusting of the details of a vendor's business logic. This allows the license management software to be used for different vendors. Vendors can have different requirements for upgrades/downgrades, license asset locking, license keys and other functionality that can be set in the customization module.

The ability to store configuration information makes the license management unit useful for the internal use of a company. The company can obtain details of the licenses from one or more vendors. In one embodiment, information from the license management unit can be copied to user internal databases.

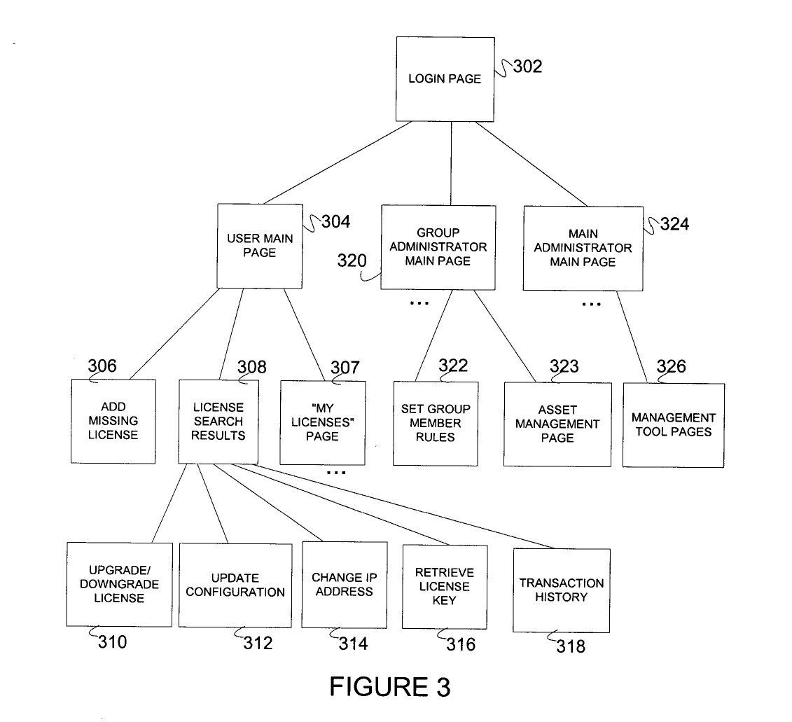

FIG. 3 is a simplified exemplary diagram of web page flow (site map) seen by users in one embodiment of the present invention. This diagram has been simplified by not showing all web pages and links between web pages. In one embodiment, portlets are used for functionality and can be used in a variety of different web pages.

The login page 302 is used for login. In one embodiment, a role such as user, group administrator, or main administrator is assigned based on the login. The roles can be implemented by using the WebLogic Portal™ product of BEA Systems, of San Jose, Calif. The roles provide security for the system such that the customers cannot access other customers licenses. Authorization can be sent to the user by e-mail, so that the e-mail address of the user is verified.

A user main page 304 allows the user to search for license(s) as well as other license related activities, including adding a missing license. The add missing license page 306 allows the user to upload information sufficient for an administrator to determine whether the user had purchased a license that is not in the license management unit database. A main administrator can review the missing license request once received to determine whether to accept the missing license.

The license search results page 308 displays search results and allows users to manipulate and review the licenses. The upgrade/downgrade license page 310 allows the user to upgrade or downgrade a license. In one embodiment of the present invention, the software version can be changed by more than one step. The user need not sequentially step through all the different product versions in order to get the desired product version. As described above, the upgrade or downgrade of the license can cause the construction of another license key. The user can separately download the new version of the software. When a new upgraded/downgraded license is created, in one embodiment, the old license is inactivated within the database.

The update configuration page (configuration input page) 312 allows the user to update the configuration information associated with a license. Configuration input pages can also be provided when the license is first accessed and after a change, such as an IP address change. In one embodiment, the configuration input pages include fields that are definable by a group administrator. These definable fields allow the group administrators to customize the collected configuration information.

The change IP address page 314 allows the user to input a new IP address for the license. If a license key is required, the key can be generated by the system and provided by the license management unit to the software user. The system can indicate that the license is no longer valid for the old IP Address.

The retrieve license page 316 allows the user to receive a copy of the license key for the software license. The license detail page 318 shows the transaction history for the license. The license detail page 318 can also show other details of the license. The transaction history can indicate any business operations performed against the license. In one embodiment, stored indications can allow the system to disable the validity of old license versions. When an upgrade or downgrade occurs, the old version is invalidated. Storing the IP address of the old version allows the user to better keep track of their licenses. Transaction detail page 319 shows the details of a selected transaction.

A “My Licenses” page 307 can be used to show a customer's most recently updated licenses. The “My Licenses” page can be used to access the functions of pages 310, 312, 314, 316, and 318.

The group administrator page 320 allows the group administrator to access all of the pages a normal user can as well as to access a set group member rules page 322. The set group member rules page 322 allows a group administrator to control the access for group members. For example, the set group member rules page 322 can be used to require the members to input a department or other field data. The license information can also include such field information required by the group administrator.

The asset management page 323 can allow searching, reporting for operational reporting, and customer specific reporting. Cross-customer reporting and analysis can also be done. In one embodiment, the group is a consultant group working with multiple clients and the cross-customer comparisons indicate differences in licensing between clients.

Main administrator pages allow the internal administrative user to do tasks required for the maintenance of the license management system. The main administrator page 324 allows the group administrator to access all of the pages a normal user can as well as to access management tool pages 326. The management tool pages 326 can allow the main administrator to approve or deny new user requests and license access requests and to add or deny a missing license. In one embodiment, the main administrator can have greater access to the license data. Administration portlets can be provided to main administrator in pages, such as pages 308, 310, 312, and 314, to give the main administrator greater ability to manipulate the software license data.

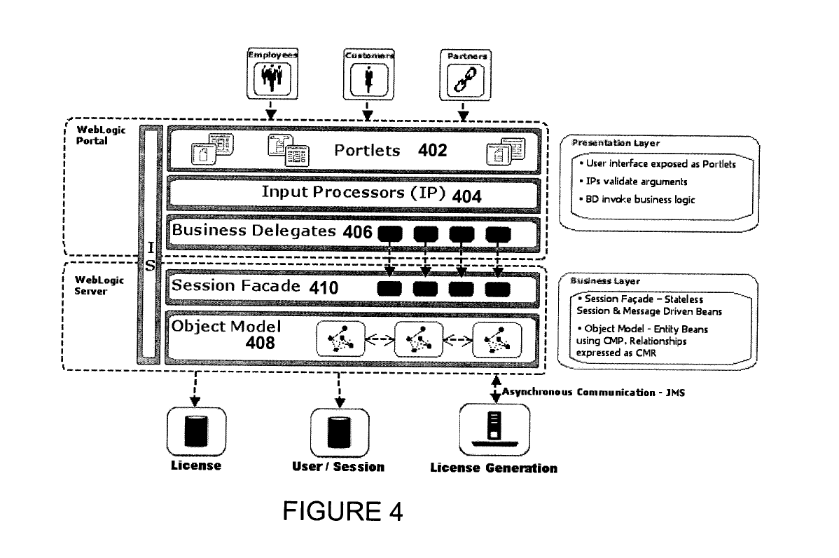

FIG. 4 illustrates a software model that can be used with one embodiment of present invention. The license management unit of the present invention need not use this model, but the model described here provides a number of advantages. The presentation layer in this embodiment includes a portlet layer 402. This layer constructs portlets and web pages. The portlet construction system can be the WebLogic Portal™ available from BEA Systems, of San Jose, Calif. The portlet pages of one embodiment are used for rendering and do not directly invoke the business layers. In one embodiment, portal security is used to only render the pages, based upon user roles.

The input processors 404 evaluates the information input by the user. For example, the input processors 404 can check to ensure that the IP address, e-mail addresses, and other fields are correct in form.

The business delegates 406 allows the presentation layer to access the business function layer. Business delegates are a known software design pattern that improves the modularity of the system

The business layer can be divided into the object model software 408 and session facade 410. The session facade logic 410 acts as a services layer. The session facade as requested by the user can provide the functionality to manipulate the object model instances. The business logic is preferably contained within this layer.

The object model 408 defines the objects, which are operated upon by the business logic in the session facade 410. In one embodiment, the objects are implemented as entity beans. In one example, Container Managed Persistence (CMP) entity beans are used. One or more of these beans can be used to contain the license record for the software licenses.

In one embodiment, the communication between layers can be done with Data Transfer Objects (DTOs). The data transfer objects contain information that is moved between the business and presentation layers. This allows the business layer and the presentation layer to be decoupled.

In one embodiment, a number of frameworks are used to help construct the system of FIG. 4. Frameworks are a way of modularizing commonly used sections of code within the design. A list framework can be used for the presentation of lists. A search framework can be used for search operations. In one embodiment, the search framework is built on top of the list framework and provides abstractions and page display capabilities. A template framework can be used for parameterizable objects. The template framework allows for the isolation of the business logic from the details of the application that uses the template. For example, e-mail programs often use templates and use of a template framework allows the use multiple independently configurable e-mail templating mechanisms by isolating details of e-mail templating form the rest of the business logic. A Notification framework can be used for the construction of a message through different channels. The notification framework isolates the business logic from the channel details. Channels can include an e-mail channel, a text messaging channel and other communication channels.

In one embodiment, the license management system is designed with modular components to ease the integration into systems, such as ERP, database, and license generator systems. The details of other systems are abstracted away by using well defined interfaces. Changes of the ERP, database or license generator systems only require a link to the interface.

One embodiment of the present invention includes maintaining digital records of software licenses for multiple groups. The groups can include users from one or more companies. The digital records indicate rights associated with a software licenses. A group administration application can be accessed to set access rules for members of a group. The rules controlling the access of digital record data of the group by members of the group. The access rules can be used to determine whether to allow a member of the group to access digital record data. A memory, which can be persistent storage implementing database, can be used to store the digital records. The group administration application can be executed on a single or multiple processors.

One embodiment of the present invention includes, after a software order, sending an e-mail message with an encrypted URL to a user. The encrypted URL is used to access a web page. A user can then download a license key from the web page. A memory can be used to store the license keys. A processor or processors can be used to produce and send the e-mail message, and to produce the web page for downloading the license key.

One embodiment of the present invention includes providing a configuration input page, the configuration input page including fields for the input of configuration information concerning a software license. The configuration input page includes fields that are definable by a group administrator so that these fields are displayed for members of the group. These field can allow the group members to input configuration information. The fields can be optional or required for the group members. In one embodiment, the login process is used to assign a user to a group, such as a company. The group member identification can be used to construct the configuration input page including the fields defined by a group administrator. A digital record is maintained of the software license. The digital record includes the configuration information. A group administration application can be used to define fields for the configuration input page. The group administration application can be used to produce a pull down list for a field of the configuration input page. The pull down list can include valid selections of configuration information for a field. The input configuration information can includes the number of CPUs, the operating system, the use environment of the software (i.e., test or production), CPU type, and IP address. Examples of group administrator selected fields include department, project name, charge numbers or any other field. In one embodiment, the user can change the IP address at which the software is licensed and the configuration input screen is provided when the user changes the IP address. The change of IP address can automatically causes the license to be invalidated at the old IP address. A transaction history can be maintained that indicates changes to the configuration information. A memory or memories can be used to store the digital record. A processor or processors can be used to provide the configuration input page.

One embodiment of the present invention includes maintaining a software license bank for a customer. The software licenses stored in the software license bank not being associated with specific machines. A web application can be accessed to allow a user to automatically obtain a software license for a specific machine from the software license bank. A memory or memories can be used to store a software license bank. A processor or processors can be used to provide the web application. The software licenses available from the software license bank can be set based on a contract. The software license bank can be set up based on a number of factors. The software license bank can store a predetermined dollar amount of licenses, a predetermined CPU count of software licenses, or a predetermined user count of software licenses. In one embodiment, the software license bank contains an unlimited number of licenses for some period of time. License keys for the software can be downloaded when a software license is removed from the software license bank.

One embodiment of the present invention includes maintaining digital records of software licenses for a group. The digital records indicate rights associated with software licenses, the digital records being accessible by a group member using a web application. A group member can access the web application to input information concerning a software license that is not stored in the digital records so as to allow an administrator to add the missing software license. A memory or memories can be used to store the digital records. A processor or processors can be used to provide the web application.

In one embodiment, a digital record of the software license is maintained. This digital record can be maintained with a license management unit. The digital record indicates rights associated with the software license. The indicated rights can be the right to execute the software indicated by the license on a given computer by an indicated user or at a given IP address. The digital records can indicate any other rights associated with the software license. The digital records can be stored in any type of memory such as a database. In one embodiment, the digital record can be stored on one or more entities defined by an object model of the license management unit. Under control of a software user, the digital record is accessed and the rights associated with the software license are adjusted. In one embodiment, the digital record is accessed by using a web-based interface to allow the software users to access a server storing the digital record. The rights associated with the software license can be modified. For example, the IP address can be changed or the software can be upgraded or downgraded. These adjustments may or may not be associated with user payments. A transaction record of adjustments of the rights associated with the software license is automatically maintained. Constructing the transaction history helps users keep track of the changes of the right associated with the license. For example, an indication of a change of the IP address or a change of software version (upgrades/downgrades) can be stored. This information can be useful for managing the licenses. For example, the software user can check the stored transaction information to see the prior status of the software licenses. Changes to the software license may invalidate previously valid licenses. The user can search on information, such as stored configuration information, to determine whether a license is invalid for a computer. For example, the transaction history can allow a user to find what license used to be associated with an IP address even after that license has changed IP addresses.

In one embodiment, digital records of software licenses are maintained. The digital records indicating rights associated with a software licenses. Under the control of a software user, the software version for multiple software licenses can be upgraded or downgraded in a batch mode. An indication of the upgrade or downgrade is stored in the digital record. The batch mode can be implemented by allowing a user to select multiple licenses. The multiple licenses can be selected from a “My Licenses” or license search result page. While multiple licenses are selected the user can select an upgrade/downgrade for the selected licenses.

In one embodiment, digital records of software licenses are maintained. The digital records indicating rights associated with a software licenses. Under the control of a software user, the software version for a software license is upgraded or downgraded. The upgrade or downgrade selected from a list of possible upgrades or downgrades. Such a list can be a pull down list on a web page. The user can select an upgrade or downgrade that skips an intermediate version. For example if the software version is 2.1 and selections of versions 2.2 and 2.3 are available the user can skip the intermediate version 2.2 and select the version 2.3. The update of the version can include providing a new license key. The old version can be invalidated.

In one embodiment, under the control of a software user, a software license is selected. The license can be selected from a “my licenses” page or a license search page for example. Automatically, a list of appropriate product versions for upgrade or downgrade of the software license is obtained. The list can be obtained from another source such as a license generation system. The list can indicate possible upgrades or downgrades based on the current license version or other information. In one example, the list is transferred to the license management unit from the license generation system as an XML file constructed based on a dependency graph indicating the possible upgrades and downgrades from a current version. The list of appropriate product versions can be provided to the software user. In one example, the list is provided to the software user as a pull-down list. The user can select one of the appropriate product versions for upgrading or downgrading the software version. Automatically, an indication of the upgrade or downgrade is stored in the digital record. The update of the version can include providing a new license key. The old version can be invalidated.

In one embodiment, the software version can be downgraded. This adds flexibility for users who may want to downgrade a license for reasons of compatibility or consistency.

The foregoing description of preferred embodiments of the present invention has been provided for the purposes of illustration and description, it is not intended to be exhaustive or to limit the invention to the precise forms disclosed. For the purposes of this application, the term “processor” is to be interpreted as to include one or more processors, and the term “memory” is to be interpreted as to include one or more memories. Many modifications and variations will be apparent to one of ordinary skill in the relevant arts. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalence.

1. A method comprising:
maintaining a software license bank for a customer, software licenses stored in the software license bank not being associated with specific machines; and
accessing a web application to allow a user to automatically obtain a software license for a specific machine from the software license bank.

2. The method of claim 1, wherein the software licenses available from the software license bank depend on a predetermined contract.

3. The method of claim 1, wherein the software license bank stores predetermined dollar amount of licenses.

4. The method of claim 1, wherein the software license bank stores a predetermined CPU count of software licenses.

5. The method of claim 1, wherein the software license bank contains an unlimited number of licenses for some period of time.

6. The method of claim 1, wherein the software license bank stores a predetermined user count of software licenses.

7. The method of claim 1, wherein the web application maintains digital records of software licenses, the digital records indicating rights associated with the software licenses.

8. The method of claim 1, wherein web application can be used to adjust the rights associated with the software license.

9. The method of claim 1, wherein the web application is used to provide license keys for the software.

10. The method of claim 1, wherein the web application uses role based security.

11. The method of claim 1, wherein the web application stores configuration information for the computers running the licensed software.

12. A license management system comprising:
a memory adapted to store a software license bank for a customer, software licenses stored in the software license bank not being associated with specific machines; and
a processor adapted to provide a web application to allow a user to automatically obtain a software license for a specific machine from the software license bank.

13. The license management system of claim 12, wherein the software licenses available from the software license bank depend on a predetermined contract.

14. The license management system of claim 12, wherein the software license bank stores predetermined dollar amount of licenses.

15. The license management system of claim 12, wherein the software license bank stores a predetermined CPU count of software licenses.

16. The license management system of claim 12, wherein the software license bank contains an unlimited number of licenses for some period of time.

17. The license management system of claim 12, wherein the software license bank stores a predetermined user count of software licenses.

18. The license management system of claim 12, wherein the web application maintains digital records of software licenses, the digital records indicating rights associated with the software licenses.

19. The license management system of claim 12, wherein web application can be used to adjust the rights associated with the software license

20. The license management system of claim 12, wherein the web application is used to provide license keys for the software.

21. The license management system of claim 12, wherein the web application uses role based security.

22. The license management system of claim 12, wherein the web application stores configuration information for the computers running the licensed software.

23. A computer readable media comprising software to instruct a computer to do the steps of:
maintaining a software license bank for a customer, software licenses stored in the software license bank not being associated with specific machines; and
in response to a user accessing a web application, allowing the user to automatically obtain a software license for a specific machine from the software license bank.

24. The computer readable media of claim 23, wherein the software licenses available from the software license bank depend on a predetermined contract.

25. The computer readable media of claim 23, wherein the software license bank stores predetermined dollar amount of licenses.

26. The computer readable media of claim 23, wherein the software license bank stores a predetermined CPU count of software licenses.

27. The computer readable media of claim 23, wherein the software license bank contains an unlimited number of licenses for some period of time.

28. The computer readable media of claim 23, wherein the software license bank stores a predetermined user count of software licenses.

29. The computer readable media of claim 23, wherein the web application maintains digital records of software licenses, the digital records indicating rights associated with the software licenses.

30. The computer readable media of claim 23, wherein web application can be used to adjust the rights associated with the software license

31. The computer readable media of claim 23, wherein the web application is used to provide license keys for the software.

32. The computer readable media of claim 23, wherein the web application uses role based security.

33. The computer readable media of claim 23, wherein the web application stores configuration information for the computers running the licensed software.
